(19) United States
(12) Patent Application Publication
(10) Pub. No.: US 2002/0009159 A1
(43) Pub. Date: Jan. 24, 2002

(54) Optical receiver

(75) Inventor: Bernd Franz, Brackenheim (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/903,542

(22) Filed: Jul. 13, 2001

(30) Foreign Application Priority Data
Jul. 15, 2000 (DE) 100 34 451.8

(51) Int. Cl. H04B 10/06

(52) U.S. Cl. 375/300; 359/189

(57) ABSTRACT

The invention relates to an optical receiver, comprising an O/E converter, in particular a photodiode, and means for the extracting a clock signal from an optically transmitted NRZ data sequence. In order to eliminate electrical components, in particular for nonlinear signal processing, in the clock signal extraction and to achieve very high bit rates accompanied by high spectral purity of the clock signal, provision is made that the means comprise an optocoupler connected upstream of the O/E converter, an optical filter, connected to the optocoupler, for splitting off a portion of the optical signal spectrum of the NRZ data sequence and an evaluation circuit.

### BACKGROUND OF THE INVENTION

The invention is based on a priority application DE 100 34 451.8 which is hereby incorporated by reference.

The invention relates to an optical receiver in accordance with optical receiver comprising an O/E converter, in particular a photodiode, and means for extracting a clock signal from an optically transmitted NRZ data sequence, comprising an optocoupler connected upstream of the O/E converter, an optical filter connected to the optocoupler, for splitting off a portion of the optical signal spectrum of the NRZ data sequence and an evaluation circuit. Such optical receivers are among the basic components of optical digital telecommunication. In this connection, the extraction of the clock signal from the optically transmitted NRZ (nonreturn to zero) data sequence is also necessary in addition to the regeneration of the actual useful signal. In a known embodiment shown in FIG. 1, said extraction takes place by means of nonlinear signal processing 2. FIG. 3a shows the optical spectrum of a digital data sequence modulated with the NRZ signal upstream of the O/E (optoelectrical) converter 1. In this connection, a finite transmitter bandwidth is assumed. In the O/E converter 1, in particular a photodiode, the E (electrical) field of the optical spectrum (FIG. 3a ) is multiplied by its conjugated complex component. However, the clock line is thereby lost. In the example shown in FIG. 3a, this is the strong spectral lines that represent a clock frequency of 40 GHz. It is evident from FIG. 3b that a 40 GHz signal is no longer present after the O/E conversion. In order to extract the clock information, nevertheless, from the electrical signal, a clock channel is tapped off the electrical signal in which a nonlinear signal processing 2 takes place. A disadvantage of this known clock extraction is, in particular, the appreciable circuit complexity, which is due to the electrical components of the clock branch. In particular, appreciable difficulties arise in producing the electrical components at very high bit rates in the 80 Gbit/s or 160 Gbit/s ranges.

### SUMMARY OF THE INVENTION

The object of the invention is to eliminate the abovementioned disadvantages and to simplify an optical receiver of the generic type in regard to the extraction of the clock signal from an optically transmitted NRZ data sequence. In addition, a greater spectral purity of the clock signal, i.e. less jitter, is desired.

According to the invention, the object is achieved by optical receiver comprising an O/E converter, in particular a photodiode, and means for extracting a clock signal from an optically transmitted NRZ data sequence, comprising an optocoupler connected upstream of the O/E converter, an optical filter connected to the optocoupler, for splitting off a portion of the optical signal spectrum of the NRZ data sequence and an evaluation circuit. The basic principle of the claimed solution is to derive a clock branch for the regeneration of the clock signal not from the O/E-converted signal, but from the optical output signal. An optocoupler connected upstream of the O/E converter, an optical filter, connected to the latter, for splitting off a portion of the optical signal spectrum of the NRZ data sequence and an evaluation circuit are provided for this purpose. In this way, the electrical components for the nonlinear signal processing can be eliminated. Instead, an all-optical clock derivation takes place. The optical components necessary for this purpose, namely an optocoupler and optical filter, can be produced, at least for very high bit rates, more easily than electrical components for the nonlinear signal processing.

In accordance with claim 2, the optical signal spectrum is O/E-converted after the all-optical clock derivation, the clock signal also containing the electrical spectrum as a result of the input-side optical subspectrum. In addition, as a result of the splitting off of the clock branch upstream of the O/E converter, a greater spectral purity of the regenerated data is retained, i.e. the proneness to jitter can be reduced in this way.

The invention is explained in greater detail below by reference to an exemplary embodiment. In the drawings:

### BRIEF DESCRIPTION OF THE DRAWINGS

FIG. 1 shows a diagrammatic representation of an optical receiver in accordance with the prior art,

FIG. 2 shows precisely the same representation of an exemplary embodiment according to the invention, and

FIGS. 3a to 3d show signal patterns associated with the receiver diagrams.

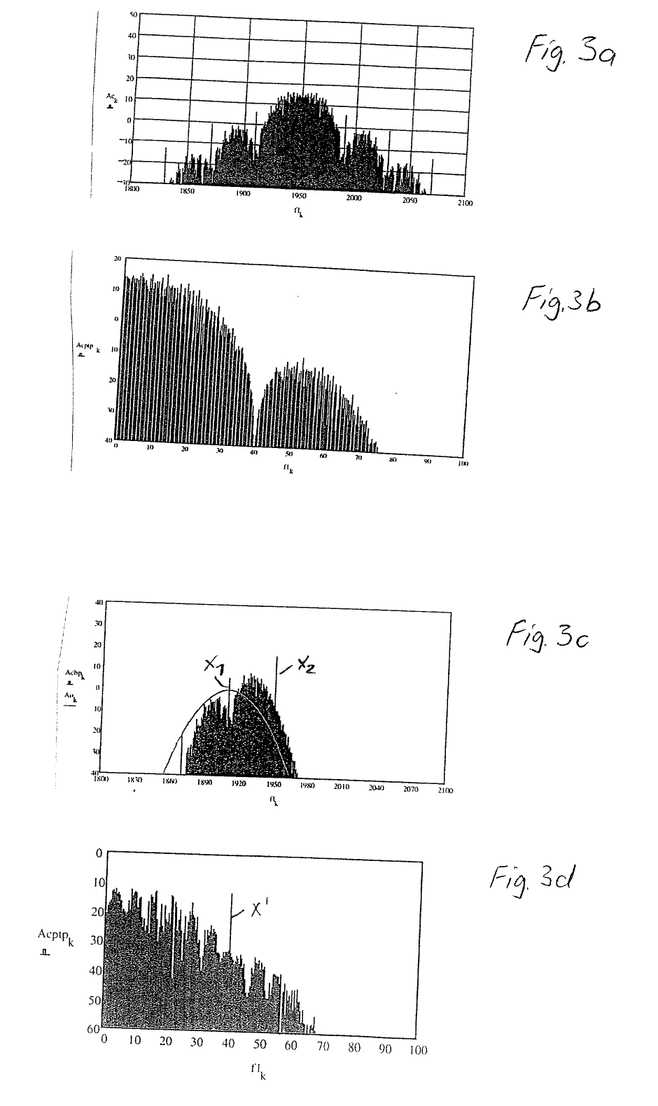

In the receiver illustrated in FIG. 1, there is inserted into the electrical branch for regenerating the useful data 4, downstream of an O/E converter 1 and an amplifier 3, a branching module 5 to which a clock branch for the extraction of a clock signal 6 is connected. The clock branch comprises electrical components connected in series one behind the other. Said components substantially comprise an amplifier 7, a nonlinear signal processor 2, a band-pass filter 8 or PLL (phase-locked loop) and a further amplifier 9. At the output end, the useful data branch and the clock branch are interconnected in the standard way via a digital flip-flop 10 and a clock distributor 1 1. In connection with FIGS. 3a and 3b, it is evident that the optical spectrum (FIG. 3a) of a digital data sequence modulated, in particular, with an NRZ (nonreturn to zero) signal appears, after the O/E conversion 1 as an electrical spectrum (FIG. 3b) that no longer contains the clock line (at 40 GHz in the exemplary embodiment). In order to regenerate the clock signal 6, a nonlinear signal processing 2 of the electrical spectrum takes place in the clock branch.

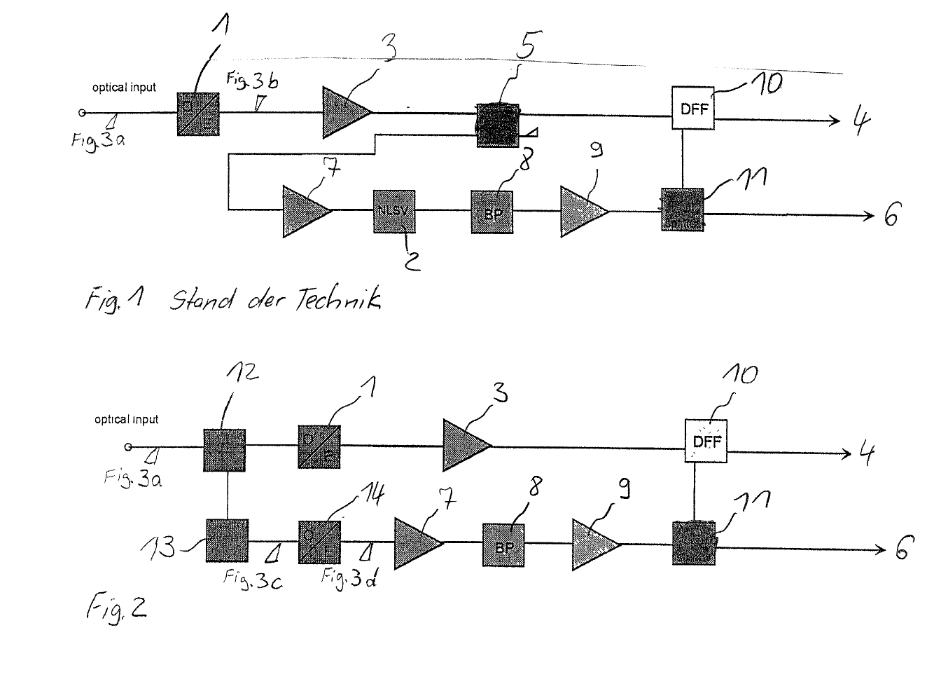

The solution illustrated in FIG. 2 differs basically from the prior art in that the optical input signal is already tapped off, only a portion of the optical spectrum being used for the extraction of the clock signal 6. The tapping-off is achieved by means of an optocoupler 12 and the reduction to a portion of the optical spectrum by means of an optical filter 13. In this way, an optical spectrum characterized in FIG. 3c results at the output of the filter 13. In this connection, the spectral composition depends on the filter characteristic Aoₖ, which has a Gaussian-curve shape in this example and which is chosen in such a way that at least one clock line x₁ is to be expected together with the optical carrier frequency x₂ in the passband of the optical filter 13. The filtered signal (FIG. 3c) is fed to an O/E regenerator 14, resulting in an electrical spectrum (FIG. 3d) that contains an electrical clock line x′ (at 40 GHz in the exemplary embodiment) corresponding to the difference between the optical spectral lines x₁ and x₂.

The invention is not restricted to the exemplary embodiment specified above. On the contrary, a number of variants are conceivable that also make use of the features of the invention in a version of fundamentally different design. For example, different types of optical filters, in particular Fabry-Perot filters, can be used.

1. Optical receiver comprising an O/E converter, in particular a photodiode, and means for extracting a clock signal from an optically transmitted NRZ data sequence, comprising an optocoupler connected upstream of the O/E converter, an optical filter connected to the optocoupler, for splitting off a portion of the optical signal spectrum of the NRZ data sequence and an evaluation circuit.

2. Optical receiver according to claim 1, with the evaluation circuit comprising an O/E regenerator, in particular a photodiode, an amplifier system and filtering means, in particular a band-pass filter (8) or a PLL (phase-locked loop).
